(19) United States
(12) Patent Application Publication
(10) Pub. No.: US 2025/0370745 A1
(43) Pub. Date: Dec. 4, 2025

(54) METHOD AND SYSTEM FOR AUTOMATED PRODUCT MIGRATION

(71) Applicant: JPMorgan Chase Bank, N.A., New York, NY (US)

(72) Inventors: Ramesh JAYAPAL, Sugar Land, TX (US); Raja VEERAPPAN, Missouri City, TX (US); Gayathiri JAYAPRAKASH, Katy, TX (US); Abhishek MADDU, Secunderabad (IN); Asmita RAHA, Kolkata (IN)

(73) Assignee: JPMorgan Chase Bank, N.A., New York, NY (US)

(21) Appl. No.: 18/774,509

(22) Filed: Jul. 16, 2024

(30) Foreign Application Priority Data
May 31, 2024 (IN) 202411042552

(51) Int. Cl. G06F 8/71; G06Q 10/10

(52) U.S. Cl. CPC G06F 8/71; G06Q 10/103

(57) ABSTRACT

A method and a system for automatically migrating projects of a computing product in phases for a version upgrade are provided. The method includes: receiving at least one input relating to projects of the computing product; identifying, based on the at least one input, at least one project of the first version of the computing product to be migrated; deploying a first intermediate instance for the first version of the computing product; copying at least one first data file of the identified at least one project from a source instance to the first intermediate instance; importing the identified at least one project from the at least one first data file into the first intermediate instance; modifying the first intermediate instance to a second intermediate instance for the second version; copying at least one second data file; and importing the at least one identified project of the second version.

### CROSS-REFERENCE TO RELATED APPLICATIONS

This application claims priority benefit from Indian Application No. 202411042552, filed on May 31, 2024 in the India Patent Office, which is hereby incorporated by reference in its entirety

### FIELD OF THE DISCLOSURE

This technology generally relates to methods and systems for migrating a first version of a computing product to a second version of the computing product in a first computing environment, and more particularly to methods and systems for automatically migrating projects of a computing product in phases for a version upgrade.

### BACKGROUND INFORMATION

Current methods for migrating product versions are big-bang and require an entire database copy. Thus, current methods of migration between infrastructure are extremely time-consuming and can cause major disruptions to businesses and production. For example, current migration of product versions results in large outage times that may last for 48 hours for each line of business. Additionally, during migration, continuous integration and continuous deployment (CI/CD) pipelines are impacted and production deployments are not allowed. Also, because the size of an entire database is often large, migration failure rate is high. These migration failures may result in network timeouts, data inconsistency, index rebuilds, and other impactful issues. Moreover, rollback to initial versions is not possible for current migration methods.

Accordingly, there is a need to provide an efficient solution to overcome the above-mentioned limitations and to provide a method and system for automatically migrating projects of a computing product in phases for a version upgrade.

### SUMMARY

The present disclosure, through one or more of its various aspects, embodiments, and/or specific features or sub-components, provides, inter alia, various systems, servers, devices, methods, media, programs, and platforms for automatically migrating projects of a computing product in phases for a version upgrade.

According to an aspect of the present disclosure, a method for migrating a first version of a computing product to a second version of the computing product in a first computing environment is provided. The method is implemented by at least one processor. The method includes: receiving, by the at least one processor, at least one input relating to projects of the computing product; identifying, by the at least one processor based on the at least one input, at least one project of the first version of the computing product to be migrated; deploying, by the at least one processor, a first intermediate instance for the first version of the computing product; copying, by the at least one processor, at least one first data file of the identified at least one project from a source instance to the first intermediate instance; importing, by the at least one processor, the identified at least one project from the at least one first data file into the first intermediate instance; modifying, by the at least one processor, the first intermediate instance to a second intermediate instance for the second version of the computing product; copying, by the at least one processor, at least one second data file of the identified at least one project of the second version of the computing product from the second intermediate instance to a destination instance for the second version of the computing product; and importing, by the at least one processor, the at least one identified project of the second version of the computing product from the at least one second data file into the destination instance.

The identifying of the at least one project may be performed by applying an artificial intelligence (AI) model that generates a phased migration plan.

The AI model may use at least one from among a project identifier, a builder node, a programming language version, a requested line of business, a number of impacted users, a business impact, and a production impact as the at least one input for the identifying of the at least one project.

The method may further include exporting, by the at least one processor prior to the deploying of the first intermediate instance, the identified at least one project to an export directory of the source instance using an Application Programming Interface (API). A plurality of projects from the identified at least one project may be grouped and processed together.

The intermediate instance may be created using an Infrastructure as Code (IaC) based on a size of the at least one project.

The method may further include prompting a user to provide input using an API for the modifying of the first intermediate instance. The method may further include comparing, by the at least one processor, metric data between the source instance and the destination instance; performing, by the at least one processor, each operation when there is a difference in the metric data between the source instance and the destination instance; repeating, by the at least one processor, the comparing and the performing until there is no difference in the metric data between the source instance and the destination instance; and transmitting, by the at least one processor, a notification that the first version of the computing product has been successfully migrated to the second version of the computing product.

The method may further include deleting, by the at least one processor following successful migration of the identified at least one project from the first version to the second version, the at least one first data file and the at least one second data file.

According to another aspect of the present disclosure, a computing apparatus for migrating a first version of a computing product to a second version of the computing product in a first computing environment is provided. The computing apparatus includes a processor; a memory; and a communication interface coupled to each of the processor, and the memory. The processor is configured to: receive, via the communication interface, at least one input relating to projects of the computing product; identify, based on the at least one input, at least one project of the first version of the computing product to be migrated; deploy a first intermediate instance for the first version of the computing product; copy at least one first data file of the identified at least one project from a source instance to the first intermediate instance; import the identified at least one project from the at least one first data file into the first intermediate instance; modify the first intermediate instance to a second intermediate instance for the second version of the computing product; copy at least one second data file of the identified at least one project of the second version of the computing product from the second intermediate instance to a destination instance for the second version of the computing product; and import the at least one identified project of the second version of the computing product from the at least one second data file into the destination instance.

The processor may be further configured to apply an AI model to identify the at least one project, and wherein the AI model generates a phased migration plan.

The AI model may use at least one of a project identifier, a builder node, a programming language version, a requested line of business, a number of impacted users, a business impact, and a production impact as the at least one input for the identifying of the at least one project.

The processor may be further configured to export, prior to the deploying of the first intermediate instance, the identified at least one project to an export directory of the source instance using an API, and wherein a plurality of projects from the identified at least one project are grouped and processed together.

The processor may be further configured to use an IaC to create the intermediate instance based on a size of the at least one project.

The processor may be further configured to prompt a user to provide input using an API for the modifying of the first intermediate instance. The processor may be further configured to: compare metric data between the source instance and the destination instance; perform at least one of identifying the at least one project of the first version of the computing product to be migrated, deploying a first intermediate instance for the first version of the computing product, copying at least one first data file of the identified at least one project from a source instance to the first intermediate instance, importing the identified at least one project from the at least one first data file into the first intermediate instance, modifying the first intermediate instance to a second intermediate instance for the second version of the computing product, copying at least one second data file of the identified at least one project of the second version of the computing product from the second intermediate instance to a destination instance for the second version of the computing product, and importing the at least one identified project of the second version of the computing product from the at least one second data file into the destination instance, when there is a difference in the metric data between the source instance and the destination instance; repeat the comparing and the performing until there is no difference in the metric data between the source instance and the destination instance; and transmit a notification that the first version of the computing product has been successfully migrated to the second version of the computing product.

The processor may be further configured to delete, following successful migration of the identified at least one project from the first version to the second version, the at least one first data file and the at least one second data file.

According to yet another aspect of the present disclosure, a non-transitory computer readable storage medium storing instructions for migrating a first version of a computing product to a second version of the computing product in a first computing environment is provided. The storage medium includes executable code which, when executed by a processor, causes the processor to: receive at least one input relating to projects of the computing product; identify, based on the at least one input, at least one project of the first version of the computing product to be migrated; deploy a first intermediate instance for the first version of the computing product; copy at least one first data file of the identified at least one project from a source instance to the first intermediate instance; import the identified at least one project from the at least one first data file into the first intermediate instance; modify the first intermediate instance to a second intermediate instance for the second version of the computing product; copy at least one second data file of the identified at least one project of the second version of the computing product from the second intermediate instance to a destination instance for the second version of the computing product; and import the at least one identified project of the second version of the computing product from the at least one second data file into the destination instance.

The storage medium may be further configured to cause the processor to apply an AI model to identify the at least one project, and wherein the AI model generates a phased migration plan.

The AI model may use at least one of a project identifier, a builder node, a programming language version, a requested line of business, a number of impacted users, a business impact, and a production impact as the at least one input for the identifying of the at least one project.

The storage medium may be further configured to cause the processor to export, prior to the deploying of the first intermediate instance, the identified at least one project to an export directory of the source instance using an API, and wherein a plurality of projects from the identified at least one project are grouped and processed together.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system, according to an embodiment.

FIG. 2 illustrates a network diagram of a network environment, according to an embodiment.

FIG. 3 illustrates a system diagram of a system, according to an embodiment.

FIG. 4 illustrates a process diagram of a process for automatically migrating projects of a computing product in phases for a version upgrade, according to an embodiment.

FIG. 5 illustrates a flow diagram of a process for automatically migrating projects of a computing product in phases for a version upgrade, according to an embodiment.

FIG. 6 illustrates a flow diagram of a process for automatically identifying projects of a computing product in phases for a version upgrade, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

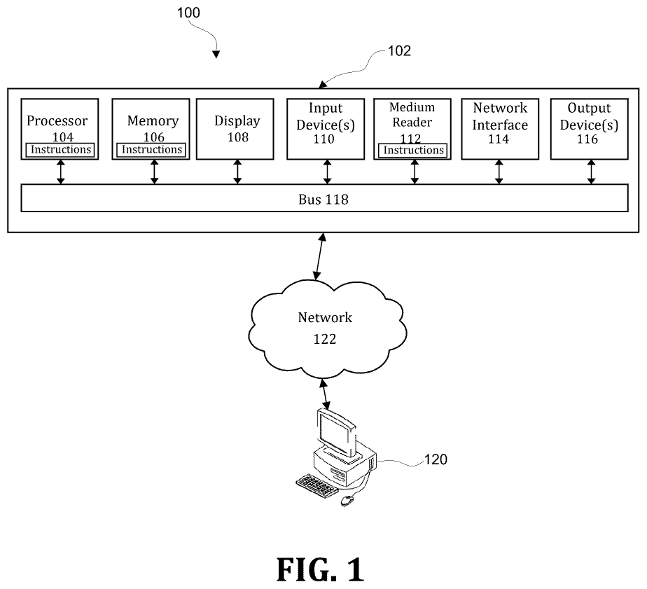

FIG. 1 illustrates a system diagram of a system 100 in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for automatically migrating projects of a computing product in phases for a version upgrade.

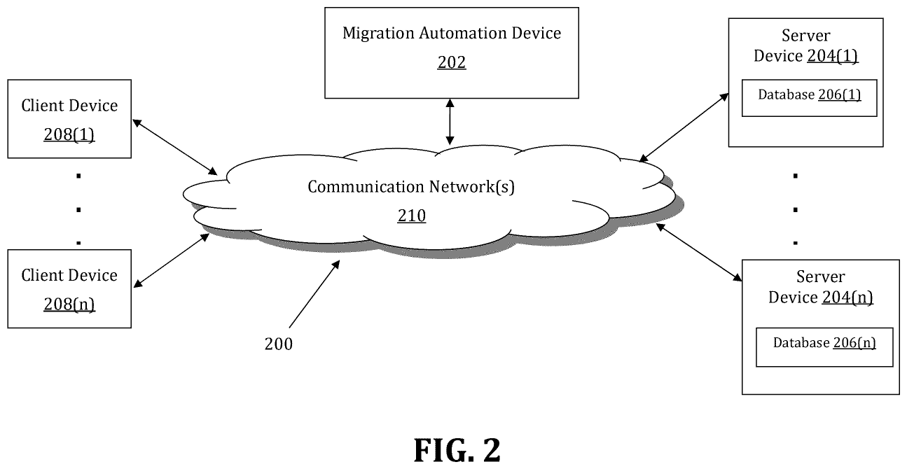

Referring to FIG. 2, a schematic of a network environment 200 for implementing a method for automatically migrating projects of a computing product in phases for a version upgrade is illustrated. In some embodiments, the method may be executable on any networked computer platform, such as, for example, a personal computer (PC).

The method for automatically migrating projects of a computing product in phases for a version upgrade may be implemented by a migration automation device 202. The migration automation device 202 may be the same or similar to the computer system 102 as described with respect to FIG. 1. The migration automation device 202 may store one or more applications that can include executable instructions that, when executed by the migration automation device 202, cause the migration automation device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the migration automation device 202 itself, may be located in virtual server(s) running in a cloud-based computing environment rather than being tied to one or more specific physical network computing devices. Also, the application(s) may be running in one or more virtual machines (VMs) executing on the migration automation device 202. Additionally, in one or more embodiments of this technology, virtual machine(s) running on the migration automation device 202 may be managed or supervised by a hypervisor.

In the network environment 200 of FIG. 2, the migration automation device 202 is coupled to a plurality of server devices 204(1)-204(n) that hosts a plurality of databases 206(1)-206(n), and also to a plurality of client devices 208(1)-208(n) via communication network(s) 210. A communication interface of the migration automation device 202, such as the network interface 114 of the computer system 102 of FIG. 1, operatively couples and communicates between the migration automation device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the migration automation device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and migration automation devices that efficiently implement a method for automatically migrating projects of a computing product in phases for a version upgrade.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The migration automation device 202 may be a standalone device or integrated with one or more other devices or apparatuses, such as one or more of the server devices 204(1)-204(n), for example. In one particular example, the migration automation device 202 may include or be hosted by one of the server devices 204(1)-204(n), and other arrangements are also possible. Moreover, one or more of the devices of the migration automation device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the migration automation device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to a model input repository and a product version database.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the migration automation device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 is a wireless mobile communication device, i.e., a smart phone.

The client devices 208(1)-208(n) may run interface applications, such as standard web browsers or standalone client applications, which may provide an interface to communicate with the migration automation device 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the migration automation device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are mere examples, as many variations of the specific hardware and software used to implement the examples are possible, as will be appreciated by those skilled in the relevant art(s).

One or more of the devices depicted in the network environment 200, such as the migration automation device 202, the server devices 204(1)-204(n), or the client devices 208(1)-208(n), for example, may be configured to operate as virtual instances on the same physical machine. In other words, one or more of the migration automation devices 202, the server devices 204(1)-204(n), or the client devices 208(1)-208(n) may operate on the same physical device rather than as separate devices communicating through communication network(s) 210. Additionally, there may be more or fewer migration automation devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

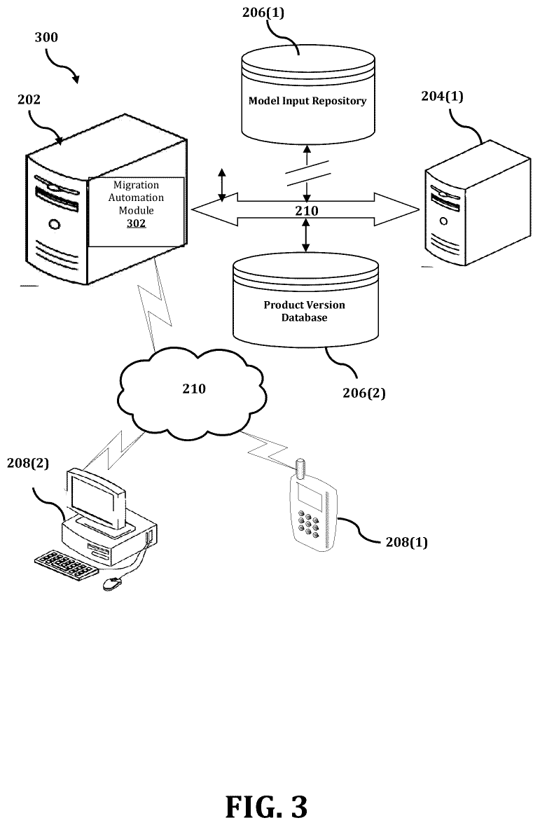

The migration automation device 202 is described and illustrated in FIG. 3 as including a migration automation module 302, although it may include other rules, policies, modules, databases, or applications, for example. As will be described below, the migration automation module 302 is configured to implement a method for automatically migrating projects of a computing product in phases for a version upgrade.

A system 300 for automatically migrating projects of a computing product in phases for a version upgrade by utilizing the network environment of FIG. 2 is illustrated as being executed in FIG. 3. Specifically, a first client device 208(1) and a second client device 208(2) are illustrated as being in communication with the migration automation device 202. In this regard, the first client device 208(1) and the second client device 208(2) may be “clients” of the migration automation device 202 and are described herein as such. Nevertheless, it is to be known and understood that the first client device 208(1) and/or the second client device 208(2) need not necessarily be “clients” of the migration automation device 202, or any entity described in association therewith herein. Any additional or alternative relationship may exist between either or both of the first client device 208(1) and the second client device 208(2) and the migration automation device 202, or no relationship may exist.

Further, the migration automation device 202 is illustrated as being able to access a model input repository 206(1) and a product version database 206(2). The migration automation module 302 may be configured to access these databases for automatically migrating projects of a computing product in phases for a version upgrade.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the migration automation device 202 via broadband or cellular communication. Of course, these embodiments are not limiting or exhaustive.

Upon being started, the migration automation module 302 executes a process for automatically migrating projects of a computing product in phases for a version upgrade.

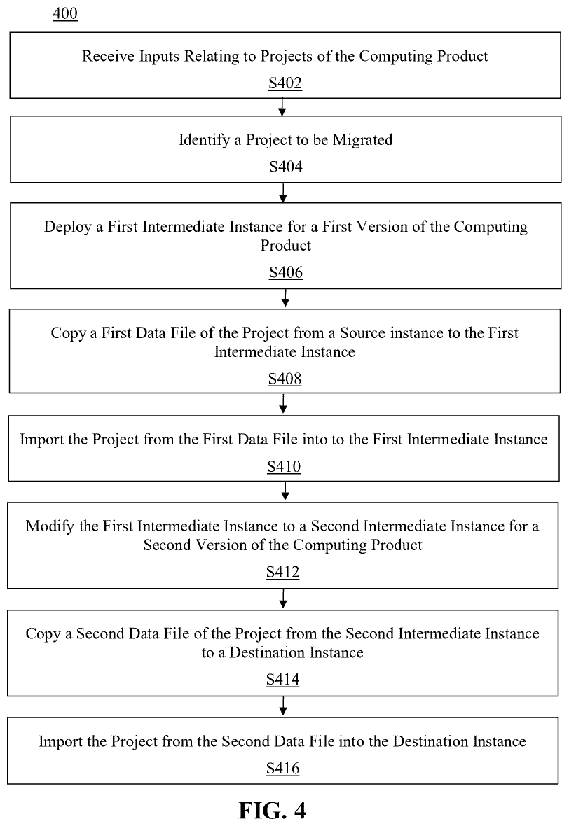

Referring to FIG. 4, a process 400 for automatically migrating projects of a computing product in phases for a version upgrade is illustrated, according to an embodiment.

In process 400 of FIG. 4, at step S402, the migration automation module 302 may receive inputs relating to projects of a computing product. In an embodiment, the inputs for identifying projects may include project IDs, builder nodes, programming language versions, line of business requested, number of impacted users, and business and/or production impacts. In an embodiment, the inputs may be used to identify the priority of migration. In some embodiments, the projects may be identified using an artificial intelligence and machine learning (AI/ML) model that uses the received inputs to identify project priority for migration. In an embodiment the AI/ML model may identify priority IDs that need migration.

At step S404, the migration automation module 302 may identify the projects to be migrated. In an embodiment, the migration automation module 302 may determine and output the project migration priority and select which of the projects will be migrated in the initial batch. In an embodiment, the selected projects may be exported from a source instance to an export folder of the source instance. In some embodiments, the identified projects may be exported from the source instance using APIs. In an embodiment, multiple projects from the same ID may be grouped and processed in a single batch.

At step S406, the migration automation module 302 may deploy a first intermediate instance for a first version of the computing product. In an embodiment, the intermediate instance may be created using an IaC (e.g., IaC-Terraform).

At step S408, the migration automation module 302 may copy a first data file of the projects from a source instance to the first intermediate instance. In some embodiments, the project data file may be copied and exported from an export folder of the source instance.

At step S410, the migration automation module 302 may import the projects from the first data file into the first intermediate instance. In some embodiments, the projects may be imported into a first version destination intermediate instance.

At step S412, the migration automation module 302 may modify the first intermediate instance to a second intermediate instance for a second version of the computing product. In an embodiment, the projects in the first intermediate instance may be upgraded from a source version to a higher version of the computing product. In some embodiments, APIs may be used for migrating the projects to a higher version. In an embodiment, a user may be prompted to provide input using an API to modify the first intermediate instance.

At step S414, the migration automation module 302 may copy a second data file of the projects from the second intermediate instance to a destination instance.

Then, at step S416, the migration automation module 302 may import the projects from the second data file into the destination instance. In some embodiments, the upgraded or second data files may be imported into the destination instance using APIs. In some embodiments, the metric data between the source instance and the destination instance may be compared. In an embodiment, each of steps S402 through S416 may be repeated until there is no difference in metric data between the source instance and the destination instance. In some embodiments, following the completion of step S416, a notification may be transmitted that a version of the computing product has been successfully migrated and/or upgraded to another version.

In an embodiment, following completion of the migration of project versions, infrastructure used for the migrating may be deleted or destroyed. For example, each of the first and second copied data files may be deleted. In an embodiment, the infrastructure may be deleted using IaC-Terraform.

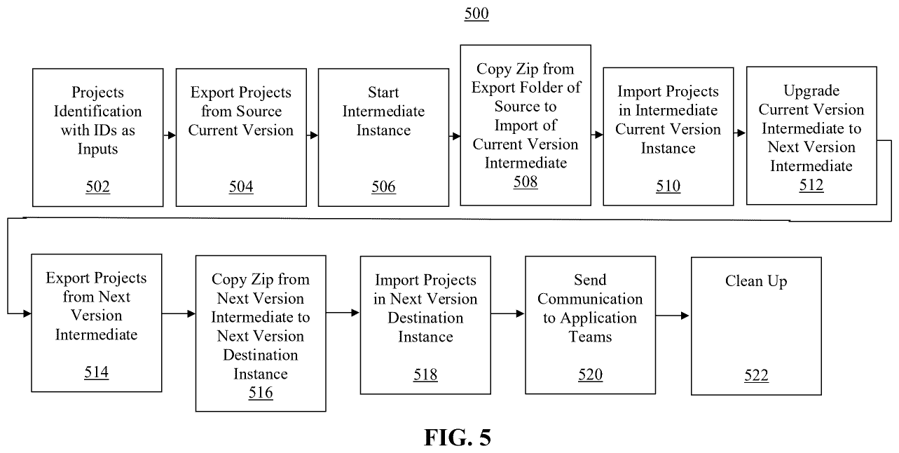

FIG. 5 illustrates a flow diagram 500 of a process for automatically migrating projects of a computing product in phases for a version upgrade, according to an embodiment. As illustrated in FIG. 5, in operation 502, projects may be identified by using IDs as inputs for the identification. In an embodiment, project identification may be done using an AI/ML model. In operation 504, identified projects may be exported from the source instance of the initial product version (i.e., current version). In operation 506, an intermediate instance is started. In some embodiments, the infrastructure may be provisioned based on project size. In operation 508, a zip file may be copied from the export directory of the source instance to the import directory of the intermediate instance using cloud storage as a medium. In operation 510, the projects may be imported into the intermediate instance. In operation 512, the intermediate instance may be upgraded to a higher instance version (i.e., next version). In operation 514, projects may be exported from the intermediate higher instance version. In operation 516, a zip file may be copied from an export directory of the intermediate higher instance version to an import directory of the destination higher instance version. In operation 518, the projects may be imported into the destination higher instance version. In operation 520, communication may be sent to the project owner regarding the status of the migration. In operation 522, the infrastructure created may be cleaned up.

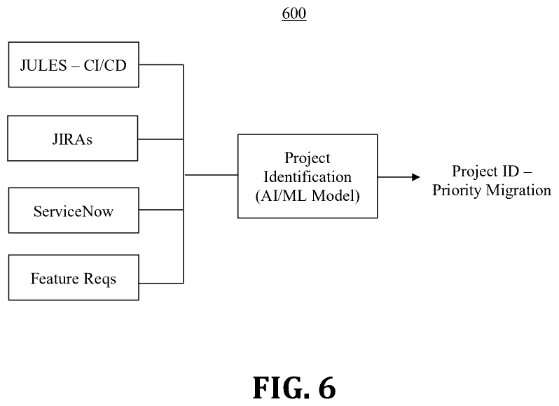

FIG. 6 illustrates a flow diagram of a process for automatically migrating projects of a computing product in phases for a version upgrade, according to an embodiment. As illustrated in FIG. 6, each of a JULES continuous integration/continuous delivery and deployment (CI/CD) software, JIRA software, ServiceNow software, and feature requests may provide inputs to the AI/ML based project identification model that uses the received inputs to output project IDs for priority migration.

In an embodiment, projects may be identified using an AI/ML model that may use the following input features: project ID, builder node (e.g., Java 17, .Net, Python etc.), programming language version, line of business requested, number of impacted users, and business and/or production impact. In an embodiment, the AI/ML model may output the project migration priority. In some embodiments, the AI/ML model may output “Yes” or “No” for each project, and if the output is “Yes” the project may be migrated in the initial batch.

In an embodiment, the migration automation module 302 is a migration static scan tool that moves projects across versions of the tool. In some embodiments, the migration automation module 302 exports a project from one instance and imports it into another instance.

In an embodiment, projects that are identified may be exported from a source instance using APIs. Multiple projects from the same ID may be grouped and processed in a single batch.

In an embodiment, the projects may be migrated in the intermediate instance. The intermediate instance may be created using an IaC (e.g., IaC-Terraform) based on project size. This instance may have both source and destination versions of the product.

In some embodiments, project files may be imported in the source version of the intermediate instance, and APIs may be used to migrate the project to a higher version of the product. Migrated project files may be in an export directory of the destination version of the intermediate instance.

In an embodiment, upgraded project files may be imported in the destination instance using the APIs. The metric data may be compared between the source and the destination. If there is no difference in metric data, an email or message may be sent to the project owner. If there is any failure/difference between the metric data, the entire workflow may be rerun for the impacted projects. In some embodiments, after successful migration of the projects, the infrastructure may be destroyed or deleted using an IaC (e.g., IaC-Terraform).

As described herein, the migration automation module 302 may provide a self-service portal so that developers and/or an application team can plan the migration. The migration may be partial or full project migration. Additionally, the migration automation module 302 may provide a workflow of steps (e.g., export project from source version, migrate project in intermediate instance and import in target version). The migration automation module 302 may also allow for zero outage to the CI/CD pipeline so that no production deployment is impacted. Additionally, migration may be split into phases instead of big bang, and if there is any failure, the migration can be restarted from the point of failure. Also, because the migration happens in phases, the migration team can validate and/or track the status of migration. The migration automation module 302 may also allow migration to be repeated multiple times without impacting existing production deployment pipelines. Moreover, migration risk (e.g., data consistency, index rebuild, etc.) may be reduced. Also, dedicated support teams for migration may be eliminated.

Accordingly, with this technology, an optimized process for automatically migrating projects of a computing product in phases for a version upgrade is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for migrating a first version of a computing product to a second version of the computing product in a first computing environment, the method being implemented by at least one processor, the method comprising:
receiving, by the at least one processor, at least one input relating to projects of the computing product;
identifying, by the at least one processor based on the at least one input, at least one project of the first version of the computing product to be migrated;
deploying, by the at least one processor, a first intermediate instance for the first version of the computing product;
copying, by the at least one processor, at least one first data file of the identified at least one project from a source instance to the first intermediate instance;
importing, by the at least one processor, the identified at least one project from the at least one first data file into the first intermediate instance;
modifying, by the at least one processor, the first intermediate instance to a second intermediate instance for the second version of the computing product;
copying, by the at least one processor, at least one second data file of the identified at least one project of the second version of the computing product from the second intermediate instance to a destination instance for the second version of the computing product; and
importing, by the at least one processor, the at least one identified project of the second version of the computing product from the at least one second data file into the destination instance.

2. The method of claim 1, wherein the identifying of the at least one project is performed by applying an artificial intelligence (AI) model that generates a phased migration plan.

3. The method of claim 2, wherein the AI model uses at least one from among a project identifier, a builder node, a programming language version, a requested line of business, a number of impacted users, a business impact, and a production impact as the at least one input for the identifying of the at least one project.

4. The method of claim 1, further comprising:
exporting, by the at least one processor prior to the deploying of the first intermediate instance, the identified at least one project to an export directory of the source instance using an Application Programming Interface (API), and wherein a plurality of projects from the identified at least one project are grouped and processed together.

5. The method of claim 1, wherein the intermediate instance is created using an Infrastructure as Code (IaC) based on a size of the at least one project.

6. The method of claim 1, further comprising:
prompting a user to provide input using an API for the modifying of the first intermediate instance.

7. The method of claim 1, further comprising:
comparing, by the at least one processor, metric data between the source instance and the destination instance;
performing, by the at least one processor when there is a difference in the metric data between the source instance and the destination instance, each operation of claim 1;
repeating, by the at least one processor, the comparing and the performing until there is no difference in the metric data between the source instance and the destination instance; and
transmitting, by the at least one processor, a notification that the first version of the computing product has been successfully migrated to the second version of the computing product.

8. The method of claim 7, further comprising:
deleting, by the at least one processor following successful migration of the identified at least one project from the first version to the second version, the at least one first data file and the at least one second data file.

9. A computing apparatus for migrating a first version of a computing product to a second version of the computing product in a first computing environment, the computing apparatus comprising:
a processor;
a memory; and
a communication interface coupled to each of the processor and the memory,
wherein the processor is configured to:
receive, via the communication interface, at least one input relating to projects of the computing product;
identify, based on the at least one input, at least one project of the first version of the computing product to be migrated;
deploy a first intermediate instance for the first version of the computing product;
copy at least one first data file of the identified at least one project from a source instance to the first intermediate instance;
import the identified at least one project from the at least one first data file into the first intermediate instance;
modify the first intermediate instance to a second intermediate instance for the second version of the computing product;
copy at least one second data file of the identified at least one project of the second version of the computing product from the second intermediate instance to a destination instance for the second version of the computing product; and
import the at least one identified project of the second version of the computing product from the at least one second data file into the destination instance.

10. The computing apparatus of claim 9, wherein the processor is further configured to apply an artificial intelligence (AI) model to identify the at least one project, and wherein the AI model generates a phased migration plan.

11. The computing apparatus of claim 10, wherein the AI model uses at least one of a project identifier, a builder node, a programming language version, a requested line of business, a number of impacted users, a business impact, and a production impact as the at least one input for the identifying of the at least one project.

12. The computing apparatus of claim 9, wherein the processor is further configured to:
export, prior to the deploying of the first intermediate instance, the identified at least one project to an export directory of the source instance using an Application Programming Interface (API), and wherein a plurality of projects from the identified at least one project are grouped and processed together.

13. The computing apparatus of claim 9, wherein the processor is further configured to use an Infrastructure as Code (IaC) to create the intermediate instance based on a size of the at least one project.

14. The computing apparatus of claim 9, wherein the processor is further configured to prompt a user to provide input using an API for the modifying of the first intermediate instance.

15. The computing apparatus of claim 9, wherein the processor is further configured to:
compare metric data between the source instance and the destination instance;
perform at least one of identifying the at least one project of the first version of the computing product to be migrated, deploying a first intermediate instance for the first version of the computing product, copying at least one first data file of the identified at least one project from a source instance to the first intermediate instance, importing the identified at least one project from the at least one first data file into the first intermediate instance, modifying the first intermediate instance to a second intermediate instance for the second version of the computing product, copying at least one second data file of the identified at least one project of the second version of the computing product from the second intermediate instance to a destination instance for the second version of the computing product, and importing the at least one identified project of the second version of the computing product from the at least one second data file into the destination instance, when there is a difference in the metric data between the source instance and the destination instance;
repeat the comparing and the performing until there is no difference in the metric data between the source instance and the destination instance; and
transmit a notification that the first version of the computing product has been successfully migrated to the second version of the computing product.

16. The computing apparatus of claim 15, wherein the processor is further configured to:
delete, following successful migration of the identified at least one project from the first version to the second version, the at least one first data file and the at least one second data file.

17. A non-transitory computer readable storage medium storing instructions for migrating a first version of a computing product to a second version of the computing product in a first computing environment, the storage medium comprising executable code which, when executed by a processor, causes the processor to:
receive at least one input relating to projects of the computing product;
identify, based on the at least one input, at least one project of the first version of the computing product to be migrated;
deploy a first intermediate instance for the first version of the computing product;
copy at least one first data file of the identified at least one project from a source instance to the first intermediate instance;
import the identified at least one project from the at least one first data file into the first intermediate instance;
modify the first intermediate instance to a second intermediate instance for the second version of the computing product;
copy at least one second data file of the identified at least one project of the second version of the computing product from the second intermediate instance to a destination instance for the second version of the computing product; and
import the at least one identified project of the second version of the computing product from the at least one second data file into the destination instance.

18. The storage medium of claim 17, wherein when executed by the processor, the executable code further causes the processor to apply an artificial intelligence (AI) model to identify the at least one project, and wherein the AI model generates a phased migration plan.

19. The storage medium of claim 18, wherein the AI model uses at least one of a project identifier, a builder node, a programming language version, a requested line of business, a number of impacted users, a business impact, and a production impact as the at least one input for the identifying of the at least one project.

20. The storage medium of claim 17, wherein when executed by the processor, the executable code further causes the processor to:
export, prior to the deploying of the first intermediate instance, the identified at least one project to an export directory of the source instance using an Application Programming Interface (API), and wherein a plurality of projects from the identified at least one project are grouped and processed together.
